(19) United States
(12) Patent Application Publication
(10) Pub. No.: US 2004/0001512 A1
(43) Pub. Date: Jan. 1, 2004

(54) Method and apparatus for peer to peer bandwidth sharing

(75) Inventors: David Carroll Challener, Raleigh, NC (US); Douglas Morgan Trent, Raleigh, NC (US)

Correspondence Address: International Business Machines Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY

(21) Appl. No.: 10/185,610

(22) Filed: Jun. 28, 2002

(51) Int. Cl. H04J 3/16

(52) U.S. Cl. 370/468; 370/477

(57) ABSTRACT

A method and apparatus for sharing bandwidth among a plurality of end users increases the bandwidth available to each user. A source signal originating from one user terminal is directed through a master bandwidth sharing device that is connected to a local telecommunications line. The master bandwidth sharing device wirelessly communicates with slave bandwidth sharing devices, each having a connection to a local telecommunications line, and aggregates the available bandwidth of the multiple telecommunications lines. Frequent and regular arbitration of the bandwidth sharing process evaluates the continued availability of slave telecommunications lines and either reconfigures the bandwidth sharing depending on bandwidth availability or terminates the wireless connection upon receipt of a release signal.

### BACKGROUND OF THE INVENTION

1. The Field of the Invention

The invention relates to the field of bandwidth aggregation and sharing over telecommunications lines and more particularly to bandwidth aggregation and sharing of “last mile” telecommunications lines among end-users on the Internet.

2. The Relevant Art

As Internet usage increases, achieving and maintaining high bandwidth has become an increasingly high priority. Broadband (high bandwidth) Internet connections, are available to some users, but those users tend to pay a high cost for that access.

Many major telecommunications providers have spent enormous amounts of money within recent years to lay millions of miles of fiber optic cable throughout the United States and the world. While such telecommunications cables are capable of providing great amounts of bandwidth to the network, much of the capacity is unused, because the opportunity for most users to obtain direct, broadband connection to this fiber backbone is constrained by physical, geographical, and financial limitations.

End user subscribers are commonly connected to this broadband fiber backbone through a network of low bandwidth copper transmission lines. These low bandwidth copper lines, frequently referred to as the “last mile,” do not provide adequate bandwidth to allow for broadband telecommunication over the Internet, despite the availability of high bandwidth on the fiber backbone. Without a solution to this “last mile” bottleneck, much of the broadband fiber backbone may remain unused indefinitely.

One manner in which the prior art has attempted to deal with this problem involves a device that is located on a user's premises and that is physically connected to multiple end user terminals through a local area network (LAN). The device receives signals from each of the end user terminals and, in effect, multiplexes the sent information such that multiple users may use a single telecommunications line for interface with the Internet.

This solution is obviously limited to the capacity of the telecommunications line between the device and the Internet. If this line happens to be susceptible to low bandwidth restrictions, then so too are each of the end user terminals subjected to low bandwidth constraints, regardless of the availability of any high bandwidth lines to which they might be ultimately connected back to the network.

This solution also has the major disadvantage of requiring physical connections between each of the end users and the prior art device. This limitation may require modification to the network of each subscriber, as well as a physical connection between distinct subscribers hoping to aggregate the available bandwidth of one entity with that of another entity. Such a connection presents a multitude of security issues between the distinct networks that have been physically combined. It also presents a management issue among all participating parties regarding at least the cost, locality, and servicing of the device.

A second prior art solution proposes a bypass of the low bandwidth “last mile” through the installation of a combination of wireless devices located at the premises of: 1) the end user, and 2) the high bandwidth backbone provider. Such a combination is proposed to offer high bandwidth connection between the end user subscriber and the high bandwidth provided via wireless communications within a prescribed subscriber area.

This second solution poses a great difficulty in that it requires modification of the existing backbone structure with a generally large financial outlay. Additionally, the high bandwidth service is available only within a relatively close distance to high bandwidth backbone structures. Subscribers who desire high bandwidth telecommunications access outside of the prescribed distance are unable to avail themselves of this system.

Therefore, what is needed is a method and system that allows for high bandwidth connection between an end user subscriber and a high bandwidth service provider, and which makes use of existing service provider topologies and network structures. Such a method and system should provide a wireless and automatic aggregation process among separate sharing entities, precluding the necessity for either direct physical connection between distinct entity networks or combined management of a single, shared device or group of devices. Such a method and system also should allow for aggregation of bandwidth without specific access to hardware or software not directly related to the bandwidth sharing process.

### OBJECTS AND BRIEF SUMMARY OF THE INVENTION

The present invention has been developed in response to the present state of the art, and in particular, in response to the problems and needs in the art that have not yet been fully solved by currently available bandwidth sharing devices and processes. Accordingly, it is an overall object of the present invention to provide an improved method and system for peer-to-peer bandwidth sharing that overcome many or all of the above-discussed shortcomings in the art.

To achieve the foregoing object, and in accordance with the invention as embodied and broadly described herein in the preferred embodiments, an improved bandwidth sharing device is provided and is configured to automatically and wirelessly aggregate and arbitrate available bandwidth with a second bandwidth sharing device. The bandwidth sharing devices are preferably connected to phone lines of a plurality of Internet users to share bandwidth between the users.

The operation of the bandwidth sharing device is controlled by a logic unit within the device. The logic unit instructions allow for a variety of circumstances, including the dynamic arbitration of multiple shared transmission lines. Additionally, the logic unit is preferably configured to allow for packet transmission among multiple bandwidth sharing devices using commonly employed protocol families, such as TCP/IP and ATM. Other transmission methods may be employed as might be appropriate.

The preferred embodiment allows the bandwidth sharing device to be a stand-alone unit with standard data and voice interconnections with typical telephone, computer, and service provider equipment and connectors. The bandwidth sharing device described requires neither installation of additional, remote hardware nor changes to the topology or structure of an existing service provider network.

The bandwidth sharing device is capable of operation in either a master or a slave mode to operate in conjunction with a plurality of bandwidth sharing devices and associated telecommunications connections. One of such bandwidth sharing devices operates in master mode while the remaining devices operate in slave mode. The operations of the slave devices are determined by the commands from the master device, which is connected to the end user terminal initiating the bandwidth sharing process.

A bandwidth sharing system is also provided and includes multiple end user terminals individually connected to the Internet through a combination of low bandwidth last mile transmission lines and broadband, or high bandwidth, transmission lines. At each interface between an end user terminal and a last mile transmission line, a bandwidth sharing device is installed and is configured to aggregate the available bandwidth of a plurality of last mile transmission lines for use by a single end user subscriber.

A method of the present invention is also described for sharing bandwidth among a plurality of bandwidth sharing devices. The process begins with the determination of the mode of operation of a master bandwidth sharing device. The master device then procures connection to a local available last mile telecommunications line.

Through wireless communications, the master device detects other bandwidth sharing devices connected to last mile telecommunications lines that are not currently in use. These other devices are then configured to operate in slave mode, controlled by instructions from the master device. The master device instructs the slave devices to determine the amount of bandwidth on the line that is available for use by communications with the master device.

Upon designation of available last mile telecommunications lines and associated bandwidth, the method continues with bandwidth sharing arbitration and bandwidth sharing between bandwidth sharing devices. The bandwidth sharing arbitration allows for continual evaluation of line and bandwidth availability. The bandwidth sharing performs all functions necessary to format, transmit, receive, and reconstruct packets and messages using wireless transmission techniques known in the art.

A bandwidth sharing session between two bandwidth sharing devices is terminated when the master device receives a proper release signal, performs any necessary communication closeout arbitration, and releases the wireless connection between the master and slave devices.

A proper release signal is sent to or initiated by the master bandwidth sharing device when either the end user subscriber terminates the Internet session or the slave bandwidth sharing device becomes unavailable and communicates its unavailability to the master bandwidth sharing device. A slave device would become unavailable upon processing a recognized priority operation or signal. For example, receipt of an incoming telephone call or commencement of an Internet session by a subscriber directly connected to the slave device (in which case the bandwidth sharing device would terminate operation as a slave device and begin operation in master mode) would be recognized as a priority activity.

A system and method as described above allows for increased bandwidth transmissions and greater end user transmission capabilities. The system requires minimal changes, if any, to the current structure of telecommunications service providers and the Internet. The method is dynamic and allows for multiple end user subscribers to take advantage of broadband communications on the Internet, without sacrificing any of the bandwidth currently available to any single subscriber—an end user subscriber always has priority over the telecommunications line to which the subscriber is connected. The advantage lies in the capability to aggregate available bandwidth of the subscriber and that of other subscribers for greater communications capacity and speed.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram illustrating one embodiment of a representative Internet system in accordance with the prior art;

FIG. 2 is a schematic block diagram illustrating one embodiment of a representative Internet system incorporating bandwidth sharing devices in accordance with the present invention;

FIG. 3 is a schematic block diagram illustrating one embodiment of a representative bandwidth sharing system in accordance with the present invention;

FIG. 4 is a schematic block diagram illustrating one embodiment of a bandwidth sharing device logic unit in accordance with the present invention;

FIG. 5 is a schematic flow chart diagram illustrating one embodiment of a method of bandwidth sharing in accordance with the present invention;

FIG. 6 is a schematic flow chart diagram illustrating specific sub-steps of the bandwidth sharing step of the method of FIG. 5; and

FIG. 7 is a schematic flow chart diagram illustrating specific sub-steps of the bandwidth sharing step of the method of FIG. 5.

### DETAILED DESCRIPTION OF THE PREFERRED EMBODIMENTS

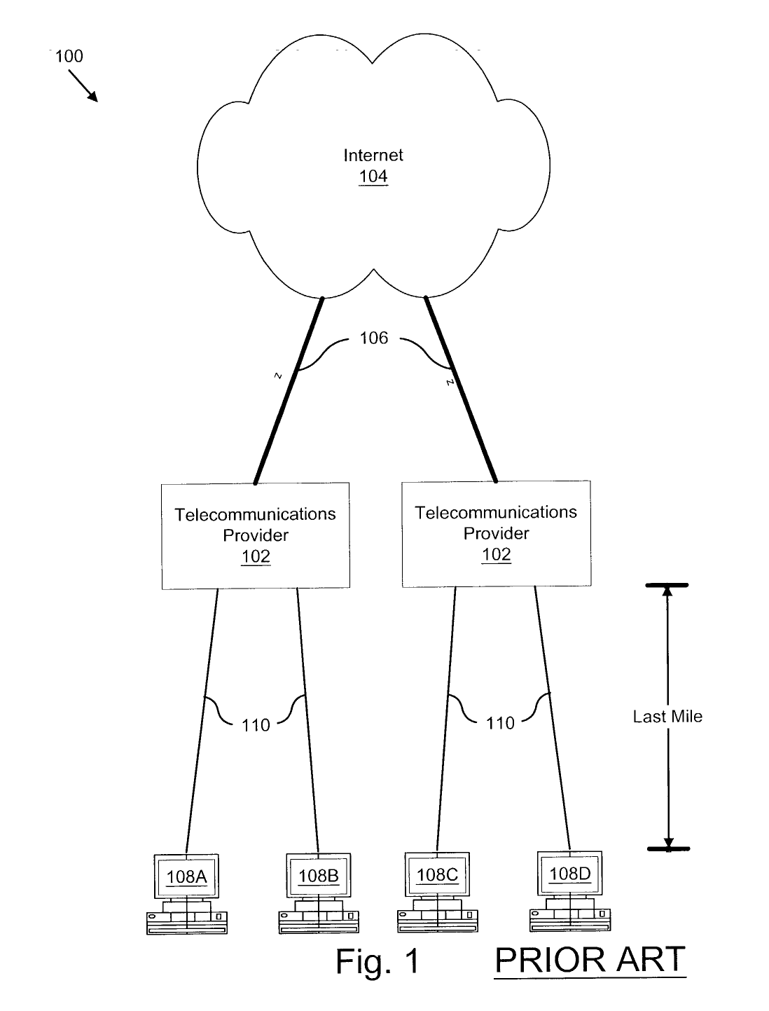

FIG. 1 shows an Internet system 100 according to the prior art. The Internet system 100 as depicted includes a plurality of telecommunications providers 102 connected to the Internet 104 via broadband telecommunications lines 106. These broadband telecommunications lines 106 may be fiber optic, coaxial, or other cables capable of high bandwidth transmission rates. Such broadband telecommunications lines 106 may be new or existing and in current use.

The telecommunications providers 102 are also connected to end user terminals 108A, 108B, 108C, and 108D. This connection between the telecommunications providers 102 and the end user terminals 108 typically consists of low bandwidth copper lines, commonly referred to as last mile telecommunications lines 110.

Due to low bandwidth capability, the last mile telecommunications lines 110 prove to be a significant bottleneck precluding broadband connectivity between the Internet 104 and the end user terminals 108, even though abundant transmission capacity is available on the broadband telecommunications lines 106.

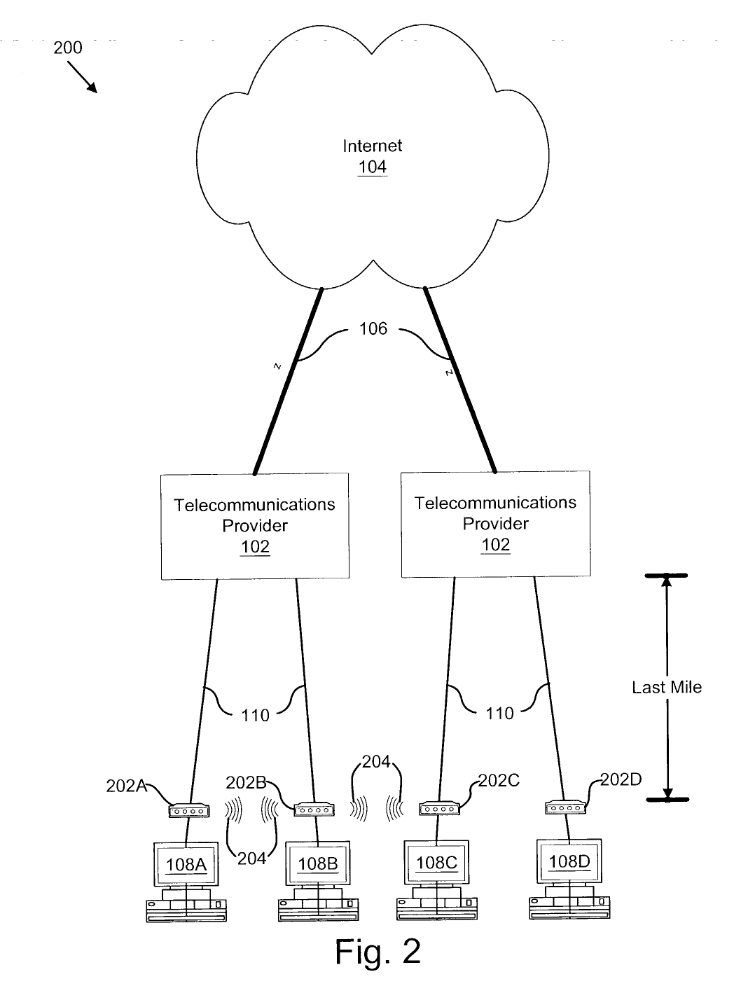

FIG. 2 illustrates an Internet system 200 in which end users employ bandwidth sharing devices 202 capable of aggregating the available bandwidth of the last mile transmission lines 110. Through this bandwidth sharing, end users are able to avoid the common bottleneck problems presented at the last mile transmission lines 110.

In the representation presented, communications signals originating from end user terminal 108B are sent to a local bandwidth sharing device 202B. The bandwidth sharing device 202B then communicates with other nearby bandwidth sharing devices 202A and 202C using wireless communications 204 to increase the bandwidth available at end user terminal 108B.

In the preferred embodiment, the communications between the end user terminals 108 and the bandwidth sharing devices 202 can occur over land lines, as in the case of a hardwired local area network, as well as through wireless communications over wireless networks as commonly known in the prior art. One such network, for instance, employs the IEEE 802.11 standard.

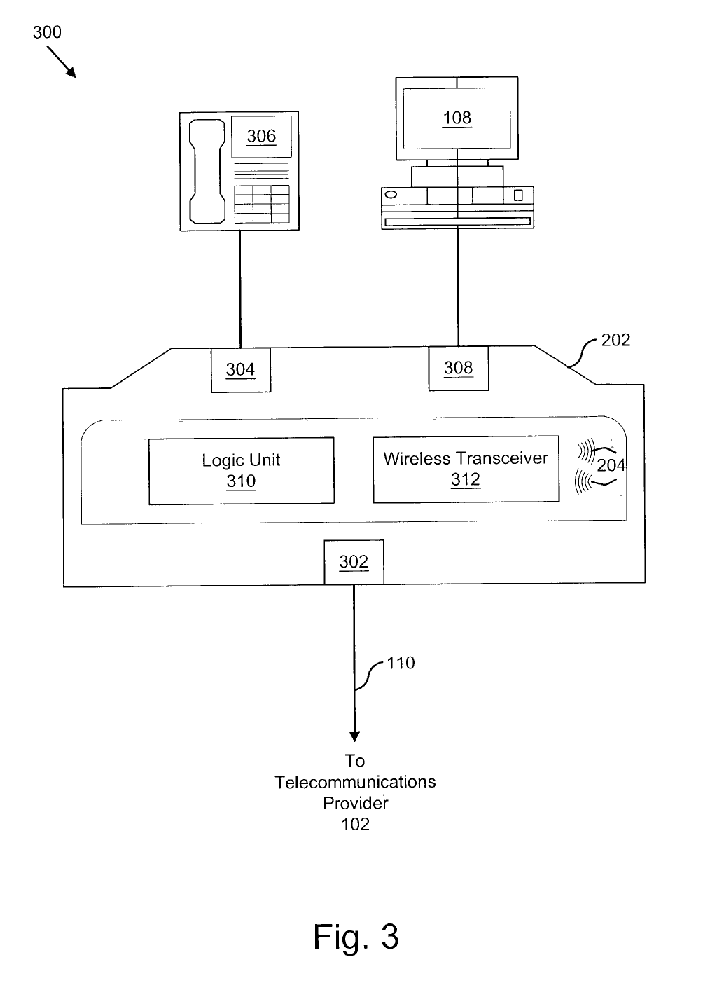

FIG. 3 shows an individual bandwidth sharing system 300 that includes a bandwidth sharing device 202. The bandwidth sharing device 202 includes a telecommunications line connection terminal 302 that allows for physical connection to a telecommunications provider 102 over a last mile telecommunications line 110. An existing telephone line into a house or office is representative of the type of last mile telecommunications line 110 that would be connected to the telecommunications line connection terminal 302.

The bandwidth sharing device 202 also includes a voice connection terminal, to which a telephone 306 might be connected, and a data connection terminal 308, to which the end user terminal 108 is connected. Once again, the preferred embodiment allows the use of hardwired and/or wireless connections between the data connection terminal 308 and the end user terminal 108.

The bandwidth sharing device 202 is controlled by a logic unit 310. The wireless communications 204 are transmitted and received by a wireless transceiver 312. The wireless transceiver 312 is capable of transmitting and receiving communications to and from a plurality of bandwidth sharing devices 202 in order to share bandwidth made available from a plurality of last mile telecommunications lines 110.

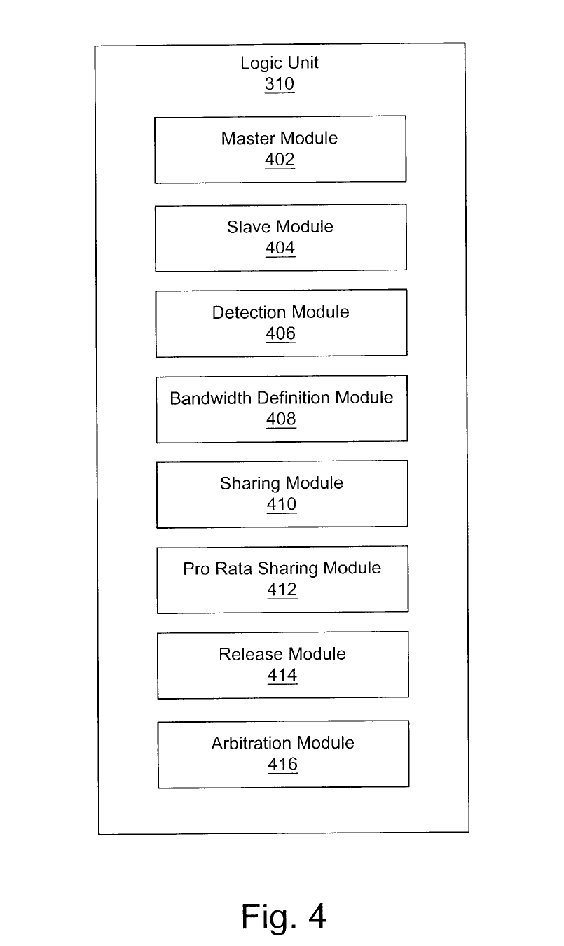

The logic unit 310 is programmed, hardwired, or otherwise provided within a plurality of modules, shown in FIG. 4. The depicted modules include a master module 402, a slave module 404, a detection module 406, a bandwidth definition module 408, an arbitration module, a sharing module 410, a pro rata sharing module 412, and a release module 514.

The master module 402 is configured to operate with a first bandwidth sharing device 202 in a master mode and to allow the first bandwidth sharing device 202 to control a second bandwidth sharing device 202 that is operating in slave mode. The first bandwidth sharing device 202 to initiate wireless communications 204 generally employs the master module 402, while bandwidth sharing devices 202 that are providing bandwidth to the first bandwidth sharing device 202 operate, at least temporarily, in slave mode.

The slave module 404 is configured to operate with a second bandwidth sharing device 202 in a slave mode that allows the second bandwidth sharing device 202 to be controlled by a first bandwidth sharing device 202 that is operating in master mode.

Referring back to FIG. 2, bandwidth sharing device 202B, might be operating in master mode while the bandwidth sharing devices 202A and 202C are operating in slave mode. Under this scenario, the Internet 104 communications originating from the end user terminal 108B benefits from increased bandwidth available through the aggregation of last mile telecommunications lines 110 connected to the bandwidth sharing devices 202A and 202C, in addition to the bandwidth available from the last mile telecommunications line 110 connected to the bandwidth sharing device 202B.

The detection module 406 is configured to detect the availability of any and all other last mile telecommunications lines 110 that are connected to operational bandwidth sharing devices 202. A bandwidth sharing device 202 connected to a last mile telecommunications line 110 with full or partial bandwidth available employs the slave module 404 and affirmatively makes known the availability of bandwidth to the requesting bandwidth sharing device 202. The detection module is initiated by a bandwidth sharing device 202 that is operating in master mode.

Following detection of an available last mile telecommunications line 110, the bandwidth definition module 508 is configured to allow a slave bandwidth sharing device 202 to communicate the amount of bandwidth that will be made available to the master bandwidth sharing device 202.

Referring back to FIG. 2, when the bandwidth sharing device 202B operates in slave mode while each of the bandwidth sharing devices 202A and 202C operate in master mode, an appropriate response by bandwidth sharing device 202B to an updated request by bandwidth sharing device 202A might be that half of the maximum bandwidth is available for use by the bandwidth sharing device 202A. The other half of the maximum bandwidth is in this example already in use by the bandwidth sharing device 202C.

Based on the response of a slave bandwidth sharing device 202, a master bandwidth sharing device 202 may be allowed to use the entire amount of bandwidth available on a last mile telecommunications line 110. In this situation, the sharing module 410 is employed.

The pro rata sharing module 412, on the other hand, is configured to allow sharing of a portion only of the available last mile telecommunications line 110. The pro rata sharing module 412 is employed in the circumstance in which two or more master bandwidth sharing devices 202 are communicating with a single slave bandwidth sharing device 202.

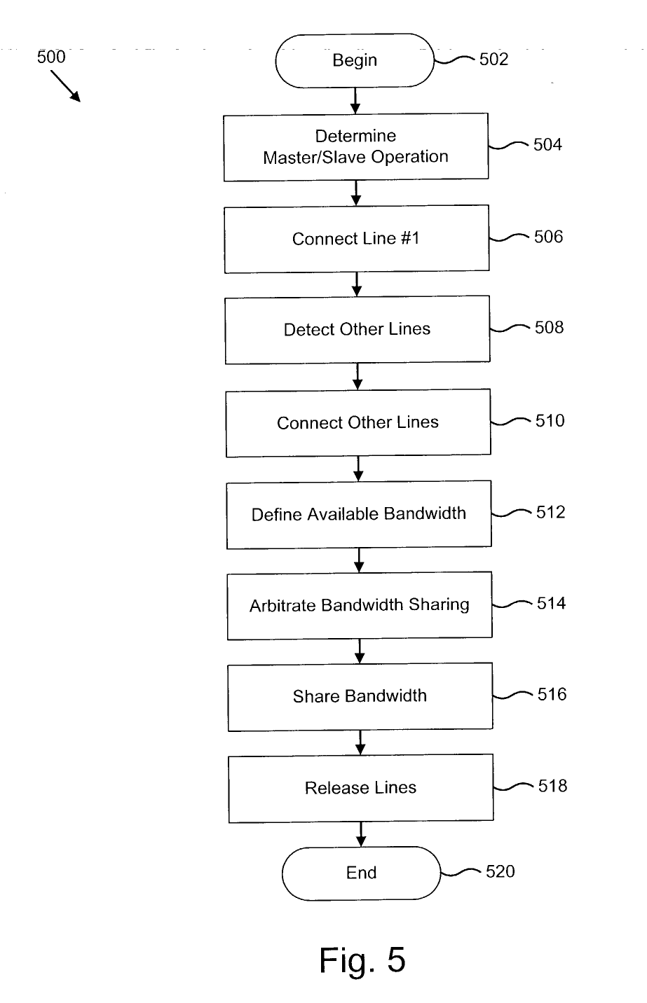

In implementation of either the sharing module 410 or the pro rata sharing module 412, the wireless communication 204 preferably uses transfer protocols such as TCP/IP and ATM that are commonly known in the present art. Further information regarding bandwidth sharing will be presented in the discussion of FIGS. 5, 6, and 7.

The logic unit 310 also includes a release module 414 that is configured to terminate wireless communications 204 over a connection to a last mile telecommunications line 110 that has become unavailable. The release module 414 is also configured to terminate wireless communications with a bandwidth sharing device 202 that has become unavailable.

An example of an operation that triggers the release module 414 is the receipt of a telephone call on a slave bandwidth sharing device 202. In such a situation, the incoming telephone call takes priority over the bandwidth sharing devices 202, and the last mile telecommunications line 110 is released and allowed to be dedicated to the signals associated with the telephone call.

Another operation that may warrant initiation of the release module 414 is termination of the entire connection to the Internet 104 by the user at the master bandwidth sharing device 202. Obviously, no further bandwidth sharing would be necessary when the user initiating the bandwidth sharing process terminates his or her Internet 104 session.

Finally, the logic unit 310 includes an arbitration module 416 configured to arbitrate the wireless communications 204 between the first and second bandwidth sharing devices 202. Such arbitration involves frequent and regular verification of the continued availability of last mile telecommunications lines 110 and re-evaluation of the amount of available bandwidth to the master bandwidth sharing device 202. The arbitration module 416 implements necessary changes, i.e., adding or removing bandwidth sharing devices to and from the current sharing method and structure in order to accommodate dynamic availability and releasing operations.

FIG. 5 is a schematic flow chart diagram illustrating one embodiment of a bandwidth sharing method 500 in accordance with the present invention. The method 500 is preferably used in conjunction with the system of FIGS. 2-4, but may also be conducted independent thereof. The method 500 begins 502 and determines 504 the operation mode of the bandwidth sharing device 202. If the bandwidth sharing device 202 in question initiates the bandwidth sharing, then it employs 504 the master module 402 and operates in master mode. Otherwise, it employs 504 the slave module 404 and operates in slave mode.

The bandwidth sharing method 500 continues by connecting 506 the master bandwidth sharing device 202 to an available last mile telecommunications line 110. Upon successful connection 506, the master bandwidth sharing device 202 proceeds to detect 508 other available last mile telecommunications lines 110 through the bandwidth sharing devices 202 to which they may be connected.

If an available last mile telecommunications line 110 is detected 508, then the master bandwidth sharing device 202 employs 504 the slave module 404 of the second bandwidth sharing device 202 and connects 510 the slave bandwidth sharing device 202 to the corresponding available last mile telecommunications line 110.

Upon connection 510, the slave bandwidth sharing device 202 defines 512 the amount of available bandwidth on the last mile telecommunications line 110 to which it is connected 510 and transmits any necessary information to the master bandwidth sharing device 202 for arbitration 514 purposes. This is conducted for each available bandwidth sharing device.

Bandwidth sharing arbitration 514 is conducted for the connected bandwidth sharing devices and includes initial configuration of the bandwidth sharing system, which is characterized by the number of active bandwidth sharing devices 202 and the corresponding amount of available bandwidth for each device. The arbitration 514 of the bandwidth sharing also necessitates frequent and regular re-evaluation of device and bandwidth availability status. Any changes to the availability of devices and/or bandwidth may require dynamic reconfiguration of the bandwidth sharing system. This is handled through bandwidth sharing arbitration 514. Actual bandwidth sharing 516 involving transmission of wireless communications 204 between bandwidth sharing devices 202 is then conducted.

As was mentioned previously, any last mile telecommunications line 110 that is needed for other purposes of higher priority, as determined by the system, is released 518 and bandwidth sharing with that entity is terminated 520. Released devices may be reconnected under an embodiment of the present invention upon detection that the device is once again available.

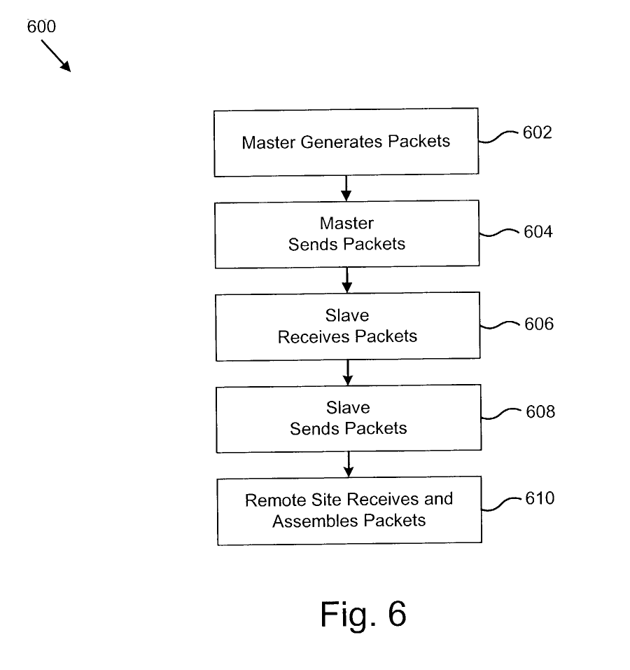

FIG. 6 illustrates one example of a method of sending communications to a remote site on the Internet during the bandwidth sharing step 516 of FIG. 5. The sending method 600 includes the steps of a master bandwidth sharing device 202 generating 602 packets for transmission from the master to one or more slaves, the master bandwidth sharing device 202 sending 604 some of the packets directly to an intended recipient at a remote site on the Internet and sending 604 an allocated portion of the packets to the slave bandwidth sharing device, preferably with wireless communication 204.

The slave bandwidth sharing device 202 receives 606 the packets, and sends 608 the packets to the intended recipient at the remote site on the Internet. The remote site then receives 610 and assembles the packets, some of which are preferably received from the master bandwidth sharing device 202 and some of which are preferably received from one or more of the slave bandwidth sharing devices.

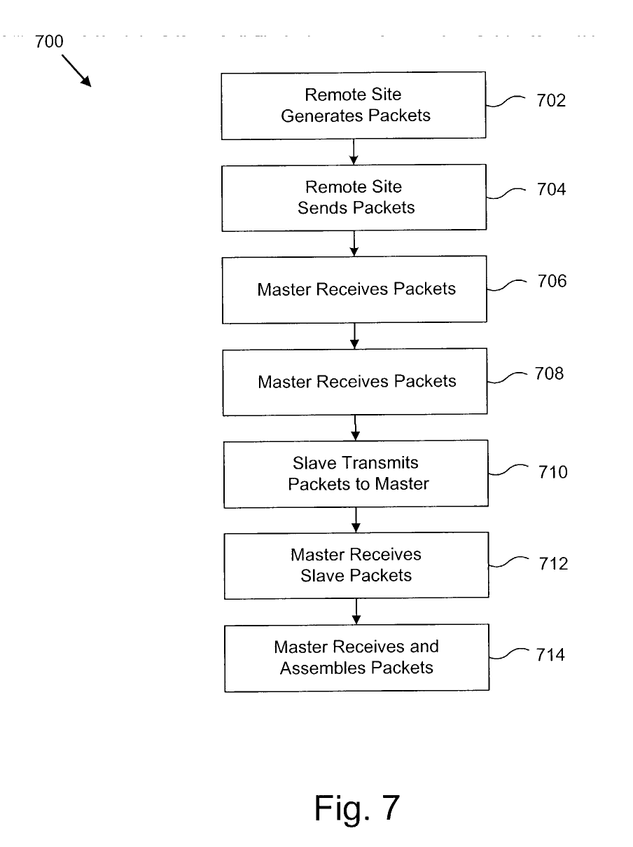

FIG. 7 illustrates one example of a method of receiving communications from a remote site on the Internet during the bandwidth sharing step 516 of FIG. 5. The receiving method 700 includes the step of the remote site generating 702 packets for transmission to the master bandwidth sharing device 202. The remote site then sends 704 some of the packets directly to the master bandwidth device 202 and sends 704 some of the packets to one or more slave bandwidth sharing devices 202.

Thus, some of the packets are received 706 by the Master bandwidth sharing devices 202 and some are received 708 by the one or more slave bandwidth sharing devices 202. The packets received by the slave bandwidth sharing devices 202 are then transmitted 710, preferably wirelessly, to the master bandwidth sharing device 202. The master bandwidth sharing device 202 then receives 712 and assembles 714 the packets.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bandwidth sharing method for aggregating available bandwidth of distinct telecommunications lines via wireless communications between a first bandwidth sharing device and a second bandwidth sharing device, the method comprising:
detecting a second available telecommunications line;
determining the availability of bandwidth on the second telecommunications line; and
sharing the available bandwidth between the first bandwidth sharing device and the second bandwidth sharing device via wireless communications.

2. The bandwidth sharing method of claim 1, further comprising connecting the first bandwidth sharing device to a first available telecommunications line and connecting the second bandwidth sharing device to the second available telecommunications line.

3. The bandwidth sharing method of claim 1, further comprising arbitrating the wireless communications between the first and second bandwidth sharing devices.

4. The bandwidth sharing method of claim 1, further comprising defining an amount of available bandwidth on the second telecommunications line.

5. The bandwidth sharing method of claim 1, further comprising the first bandwidth sharing device consuming the entirety of the available bandwidth on the second telecommunications line.

6. The bandwidth sharing method of claim 1, further comprising the first bandwidth sharing device consuming a pro rata portion of the available bandwidth on the second telecommunications line.

7. The bandwidth sharing method of claim 1, wherein the detection of and connection to the second available telecommunications line are conducted automatically.

8. The bandwidth sharing method of claim 1, wherein the first and second telecommunications lines are hard-wired land telecommunications lines.

9. The bandwidth sharing method of claim 1, wherein the first and second telecommunications lines are wireless telecommunications lines.

10. The bandwidth sharing method of claim 1, further comprising automatically releasing the second telecommunications line upon receipt of a priority telephone communication directed to a communication device connected to the second telecommunications line.

11. The bandwidth sharing method of claim 1, further comprising automatically releasing the second telecommunications line upon receipt by the second bandwidth sharing device of a wireless communication from the first bandwidth sharing device signaling termination of bandwidth sharing communications.

12. A bandwidth sharing method for aggregating available bandwidth of distinct telecommunications lines via wireless communications between a first bandwidth sharing device and a second bandwidth sharing device, the method comprising:
connecting the first bandwidth sharing device to a first available telecommunications line;
detecting a second available telecommunications line;
defining an amount of available bandwidth on the second telecommunications line;
connecting the second bandwidth sharing device to the second available telecommunications line;
arbitrating the wireless communications between the first and second bandwidth sharing devices;
sharing the available bandwidth, at least in part, between the first bandwidth sharing device and the second bandwidth sharing device via a wireless communication; and
releasing the second telecommunications line upon receipt of a proper terminating event.

13. A bandwidth sharing device for aggregating available bandwidth of a first telecommunications line and a second telecommunications line via wireless communications with a second bandwidth sharing device, the bandwidth sharing device comprising:
a wireless transceiver;
a logic unit having an arbitration module configured to arbitrate wireless communications that are sent across the wireless transceiver between the bandwidth sharing device and the second bandwidth sharing device; and
a connection between the wireless transceiver and the first telecommunications line.

14. The bandwidth sharing device of claim 13, further comprising a master module within the logic unit that is configured to operate the bandwidth sharing device in a master mode that allows the bandwidth sharing device to control the second bandwidth sharing device that is operating in a slave mode.

15. The bandwidth sharing device of claim 13, further comprising a slave module within the logic unit that is configured to operate the bandwidth sharing device in a slave mode that allows the bandwidth sharing device to be controlled by the second bandwidth sharing device that is operating in a master mode.

16. The bandwidth sharing device of claim 13, further comprising a detection module within the logic unit that is configured to detect the second available telecommunications line.

17. The bandwidth sharing device of claim 13, further comprising a bandwidth definition module within the logic unit that is configured to define an amount of available bandwidth on the second telecommunications line.

18. The bandwidth sharing device of claim 13, further comprising a sharing module within the logic unit that is configured to allow the bandwidth sharing device to consume the entirety of an amount of available bandwidth on the second telecommunications line.

19. The bandwidth sharing device of claim 13, further comprising a pro rata sharing module within the logic unit that is configured to allow the bandwidth sharing device to consume a pro rata portion of an amount of available bandwidth on the second telecommunications line.

20. The bandwidth sharing device of claim 13, further comprising a release module within the logic unit that is configured to release the connection to the first telecommunications line upon receipt of a priority telephone communication directed to a communication device connected to the first telecommunications line, when the bandwidth sharing device is operating in a master mode, and release the connection to the first telecommunications line upon receipt by the bandwidth sharing device of a wireless communications from a second bandwidth sharing device signaling termination of bandwidth sharing communications, when the bandwidth sharing device is operating in a slave mode.

21. A bandwidth sharing system comprising:
A first bandwidth sharing device operating in a master mode and capable of aggregating available bandwidth of distinct telecommunications lines via wireless communications;
a second bandwidth sharing device operating in a slave mode and capable of wireless communications with the first bandwidth sharing device;
a connection between the first bandwidth sharing device and a computer terminal;
a connection between the first bandwidth sharing device and a first telecommunications line with access to the Internet via a telecommunications provider;
a connection between the second bandwidth sharing device and a second telecommunications line with access to the Internet via a telecommunications provider; and
a logic unit capable of controlling a sharing of the available bandwidth of the first and second telecommunications lines via wireless communications and arbitrating the wireless communications between the first and second bandwidth sharing devices.

22. A bandwidth sharing device comprising:
means for connecting to a first available telecommunications line;
means for operating in a master mode;
means for operating in a slave mode;
means for detecting a second available telecommunications line;
means for defining an amount of available bandwidth on the second telecommunications line;
means for sharing the available bandwidth, either in its entirety or on a pro rata basis, from the second telecommunications line via a wireless connection with a second bandwidth sharing device connected to the second telecommunications line;
means for arbitrating the wireless communications with the second bandwidth sharing device; and
means for discontinuing the wireless communications with the second bandwidth sharing device upon receipt of a proper terminating event.

23. A bandwidth sharing system comprising:
means for connecting a first bandwidth sharing device to a first available telecommunications line with access to the Internet;
means for detecting a second bandwidth sharing device connected to a second available telecommunications line with access to the Internet;
means for connecting the second bandwidth sharing device to the second available telecommunications line;
means for determining availability of bandwidth on the second telecommunications line;
means for defining an amount of available bandwidth on the second telecommunications line;
means for sharing the available bandwidth, either in its entirety or on a pro rata basis, between the first bandwidth sharing device and the second bandwidth sharing device via wireless communications;
means for arbitrating the wireless communications between the first and second bandwidth sharing devices; and
means for releasing the second telecommunications line upon receipt of a proper terminating event.
